(19) United States
(12) Patent Application Publication
(10) Pub. No.: US 2017/0121110 A1
(43) Pub. Date: May 4, 2017

(54) WAREHOUSE AND RETRIEVAL TRUCK FOR WAREHOUSE

(71) Applicant: UNIX AUTO KFT, Budapest (HU)

(72) Inventor: Antal ZOMBORI, Budapest (HU)

(21) Appl. No.: 15/302,023

(22) PCT Filed: Apr. 2, 2015
(86) PCT No.: PCT/HU2015/000032

§ 371 Date: Oct. 5, 2016

(30) Foreign Application Priority Data
Apr. 7, 2014 (HU) P1400194

(51) Int. Cl. B65G 1/04

(52) U.S. Cl. CPC B65G 1/0492

(57) ABSTRACT

The invention relates to a cargo handling system for warehouses, comprising at least one handling equipment (4) movable in a cargo handling area (3) formed between at least two parallelly arranged rows of columns (1) and storing units (2) arranged on the columns (1), and a track (5) consisting preferably of two parallel rails arranged parallelly to the rows of columns (1) is installed in the handling area (3), and a passive hoisting member (1a) of a hoisting device connectable to an active hoisting member (13) of the hoisting device mounted on the handling equipment (4) is arranged on the columns (1), and at least one further track (51,52) fixed to the columns (1) parallelly to the track (5) is arranged in the handling area (3), and the track (51,52) is discontinuated by a gap (R). The invention also relates to a retrieval truck (4) movable along said tracks (5,51,52).

The invention relates to a cargo handling system for warehouses according to the invention, comprising at least one retrieval truck movable in a cargo handling area formed between at least two parallelly arranged rows of columns and storing units arranged on the columns, and a track consisting preferably of two parallel rails arranged parallelly to the rows of columns is installed in the handling area, and a passive hoisting member of a hoisting device connectable to an active hoisting member of the hoisting device mounted on the retrieval truck is arranged on the columns, and the system is provided with a control unit controlling the movement of the retrieval truck, and a retrieval truck for moving goods stored or being to be stored in a cargo handling system having a frame equipped with active hoisting member, wheels to be engaged with tracks, drive means for driving said wheels, and means for moving goods.

Widespread automatic cargo handling systems for warehouses have been developed for operating by looking up storing places of goods stored generally on racks in a warehouse and moving the storage unit, like a container, pallet, cage or box containing many items from the storing place to a packaging workstation A self-propelled transporter-loader device of such a system is adapted to find the respective storage unit, moving it to a packaging workstation and delivering the desired item at the packaging workstation either manually or mechanically and to place it in a package along with other goods to be forwarded to its destination. The storage unit is then reshipped by the transporter-loader device to its appropriate storage place.

Most automated storage systems have the fundamental disadvantage that only one loader device can work in a single row of racks at the same time, so that the number of operation executable per unit of time in a particular warehouse, that is the number of moved storage units per unit of time, is determined by the maximum power of this device. Parallel operation of load-carrying elements, that is for work to be carried out at the same time and in the same shelf row is not possible. A similar solution is disclosed by the document U.S. Pat. No. 6,929,440 B1, wherein the storage system comprises a number of shelves, which are arranged in several levels, and loading tracks extend horizontally along the shelving levels. Loading plates having guide members are located in front of each shelf areas. Transport means are arranged on guide members for which vertical conveyors lift up the crates or pallets loaded with commodity to be stored, which can be pushed to the shelf areas or drawn out therefrom by transport means horizontally running on the loading plates. Obvious drawback of this solution is that it is extremely investment intensive, because lifting equipment and means of transport must be installed for each shelf.

To overcome this drawback the patent document HU 229 022 proposes an arrangement for storage comprising a warehouse rack containing shelves located on columns, a handling machine movable to the designated shelf of the warehouse rack, and a handling device capable of placing goods or a storing device for storing goods on the shelves or retrieving them from the shelves and moving them to a designated location. A passive lifting device is associated with the warehouse rack and the handling machine is formed as a locomotive handling machine capable of moving on a prescribed path. The handling device is located on the handling machine, and that on the handling machine an active lifting device is arranged, which can be engaged with the passive lifting device and in cooperation with the passive lifting device moving the handling machine to a designated shelf.

This solution solves the problem of parallel operation mentioned above by managing storage units (boxes, pallets) by means of robots, since an active lifting device, which is preferably a driven cable drum mounted on a self-propelled loader structure, can be attached to a shelf-mounted passive device, preferably a rope, elevates himself like an elevator to the proper storage unit, for example a crate to be lifted out and delivered to the packing station. Thus, more than one self-propelled loader device or loading machine can work in a single row of shelves at a time increasing the number of storage units (e.g. crates) removed or placed during the same period of time. Though this solution is far more effective and its investment costs much less than that of the automatic ware management systems used previously, we must continue to reckon with the disadvantage that for obtaining only one or a few batch of commodity a whole storage unit (e.g. crates or pallets) must be transported to the packing station, where the necessary quantity of goods is removed from that storage unit—or inserted there into—and the storage unit must be transferred back to the storage area and placed for storage in the appropriate place on the shelf system. Removing, transferring and returning a storage unit (e.g. crate or pallet) all take a significant amount of time in the case of e.g. storing machine parts or usually in a commercial activity, with which only one or at most a few of a type of commodities must be delivered, and moving each necessary storage units takes a lot of time, or many robots must work at a time. In these cases, a number of boxes must be delivered to a packing point, in which only one or two commodities are to be removed, then the crate or pallet with the rest quantity must be returned. This process not only takes a long time, but also needs a lot of energy, for example a storage unit containing hundred items is to be removed from its storing place to remove only one piece to be delivered, and then the unit mist be transported back to the shelf system, with the remaining 99 pieces. Thus, 99% of the energy for transporting is used unnecessarily.

In contrast, with the warehouses of manual handling the warehouseman travels through the warehouse or a part thereof along a planned route and collects the products to be delivered in a collecting device (typically crates, pallets, etc). In this case a warehouseman takes off the shelf an amount of products just needed and no unnecessary handling of products occurs. Such a solution is disclosed by patent document US 2011142581 A1, wherein a method and an apparatus for manual order picking of items in an order-picking installation with a dynamic-storage rack as a store for the manual order picking are described. It is proposed that the items are automatically transported, preferably separately according to type, in containers or boxes to the dynamic-storage rack/flow shelf on a driven conveying line. After reading and identifying the containers, they are automatically introduced by an activated stationary lift and activated level conveyor unit of the dynamic-storage rack into selected dynamic-storage channels. The channels have exits that can be manually reached by an order picker. Items are fed by an order picker at the picker's order-picking station in an order-related manner from a container/box at a selected exit of a dynamic-storage channel to a provided order container. By increasing the number of pickers the storage capacity can be changed freely, and more than one picker can work in the same row at the same time. Therefore, this solution is much more flexible and efficient than the solutions for fully automated warehouses, but it is more expensive at the same time because of its much more demand for manual labor.

Therefore, an object of the present invention is to provide a cargo handling system for warehouses, which eliminates the drawbacks of the prior art solutions, but without the use of manual labor, that is no need either transporting storing units (like crates, pallets) containing articles stored in the warehouse to a delivery workstation or lowering the retrieval truck to the ground after each visit done at a storing unit in the warehouse in order to store or deliver stored articles by mechanical power—to save substantial amount of energy, time and live labour as well.

A further object of the invention is to provide retrieval truck for warehouses, which is capable of either placing or removing even a single item in a storage unit (e.g. a crate, a pallet) arranged in a shelf system, and forwarding the collected items to a delivery workstation or transporting items or goods to be stored to a predetermined storage unit placed in the storage shelving system.

Objects above can be achieved by providing a cargo handling system for warehouses according to the invention, comprising at least one retrieval truck movable in a cargo handling area formed between at least two parallelly arranged rows of columns and storing units arranged on the columns, and a track consisting preferably of two parallel rails arranged parallelly to the rows of columns is installed in the handling area, and a passive hoisting member of a hoisting device connectable to an active hoisting member of the hoisting device mounted on the retrieval truck is arranged on the columns, and the system is provided with a control unit controlling the movement of the retrieval truck, and at least one further track fixed to the columns parallelly to the track is arranged in the handling area, and the retrieval truck comprises: a gathering bin, a manipulator adapted for moving articles from a storing unit into said gathering bin, wheels to be fitted in the tracks and movable between at least two positions taken in an axial direction perpendicular to the lateral surfaces of the retrieval truck, a drive for rotating and moving the wheels in axial direction, a further drive for operating and moving the active hoisting member of the hoisting device between two positions taken in said axial direction perpendicular to the lateral surfaces of the retrieval truck, wherein the track is discontinuated by a gap in the vicinity of said passive hoisting member.

The system advantageously comprises more than two rows of columns arranged parallelly and handling areas therebetween; tracks formed by two parallel rails arranged perpendicularly to the rows of columns for guiding the retrieval truck; and the retrieval truck is provided by wheels to be fitted to the track and movable between two different positions along a height of the retrieval truck, and a driving unit for driving and moving said wheels between the two positions; the track perpendicularly arranged to the rows of columns and a track arranged parallelly to the rows of columns constitute a crossing.

The system preferably comprises at least one further track arranged perpendicularly to the rows of columns, and a vertical distance between the tracks parallelly arranged to the rows of columns is at least equal to the height, and the further track arranged perpendicularly to the rows of columns and the track arranged parallelly to the rows of columns constitute a crossing.

A vertical distance between tracks arranged parallelly to the rows of columns is at least equal to the height.

The manipulator adapted for moving articles is arranged on a guiding rail formed on a frame of the retrieval truck.

The retrieval truck is provided at least two pairs of wheels on each of its lateral surface, wherein the distance of axes of wheels in each pair of wheels is at least equal to or greater than a width of the gap.

The storing units are arranged movably in a direction toward the handling area on a guiding element fixed to the column, and the retrieval truck is provided with a tractive element suitable for guiding, retaining as well as driving the storing units in perpendicular direction to the rows of columns.

The gathering bin is releasably clamped to the retrieval truck.

The objects of the invention can also be achieved by providing a retrieval truck for moving goods stored or being to be stored in a cargo handling system according to the invention having a frame equipped with active hoisting member, wheels to be engaged with tracks, drive means for driving said wheels, and means for moving goods, the retrieval truck further comprises: a gathering bin arranged in the frame, a wheel movable between two positions along at least an axial direction perpendicular to the lateral surfaces of the retrieval truck to be engaged with the track in one of its two positions, and an active hoisting member movable between two positions along said axial direction perpendicular to the lateral surfaces of the retrieval truck to be engaged in one of its two positions with a passive hoisting member of the cargo handling system, and said means for moving goods comprises a manipulator adapted for moving articles from a storing unit into said gathering bin.

The retrieval truck further comprises a tractive element suitable for guiding, retaining as well as driving the storing units in perpendicular direction to the rows of columns.

The retrieval truck further comprises a wheel movable between two different positions and to be engaged in its lower position with a track perpendicularly arranged to the track of the cargo handling system.

The retrieval truck further comprising a tractive element arranged above the gathering bin, and said manipulator is mounted on a guiding rail attached to the frame above the tractive element.

The gathering bin is releasably clamped to the frame.

The invention will be further disclosed in details by describing most preferred embodiments of the system according to the invention referring to the attached drawing. In the drawing

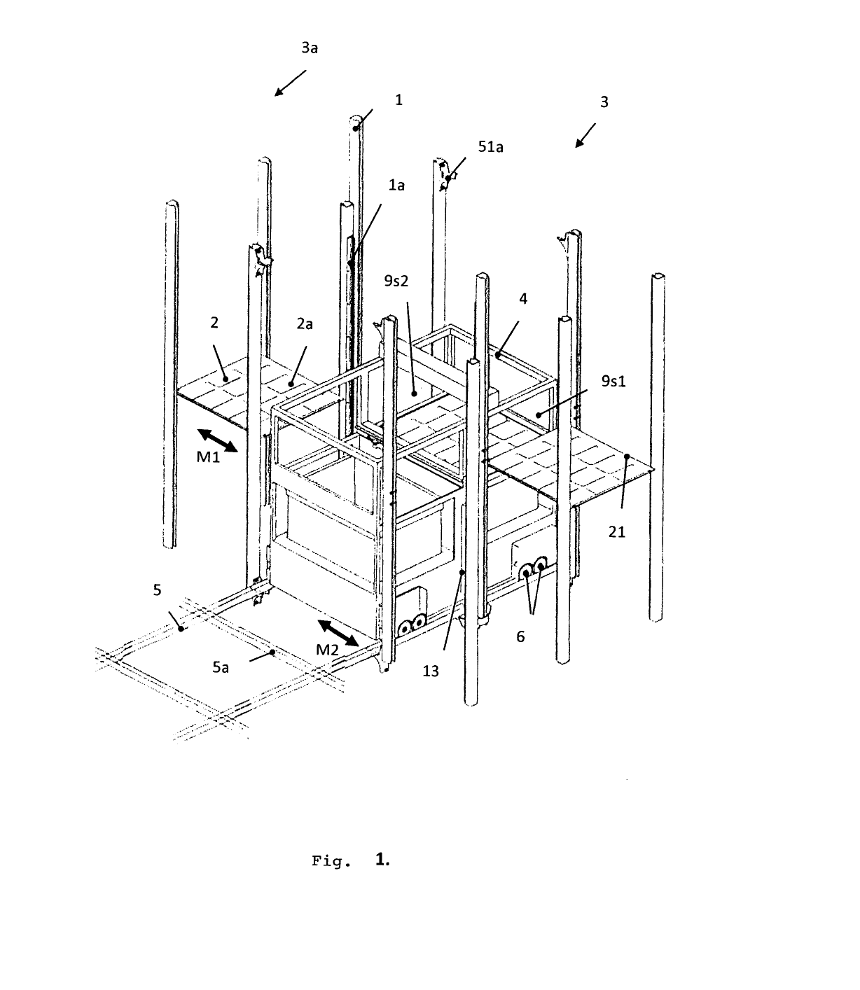

FIG. 1 shows a partial view of a preferred embodiment of the automatic cargo handling system for warehouses according to the invention,

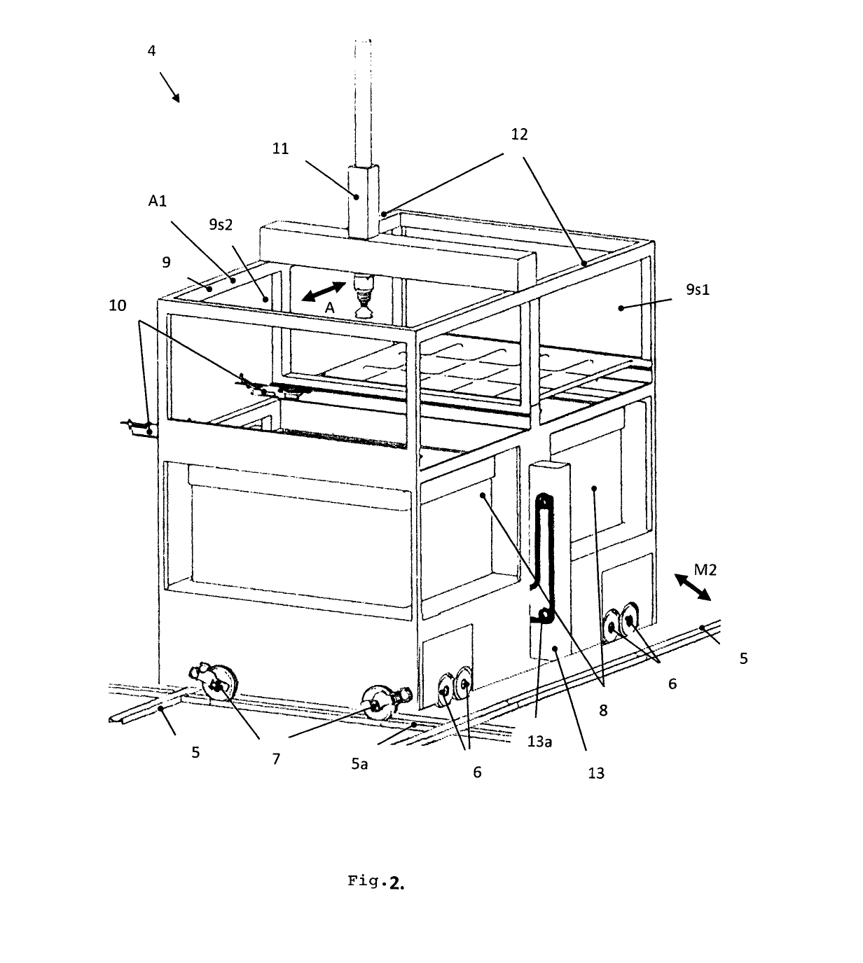

FIG. 2 depicts the structure of the retrieval truck according to the invention, in

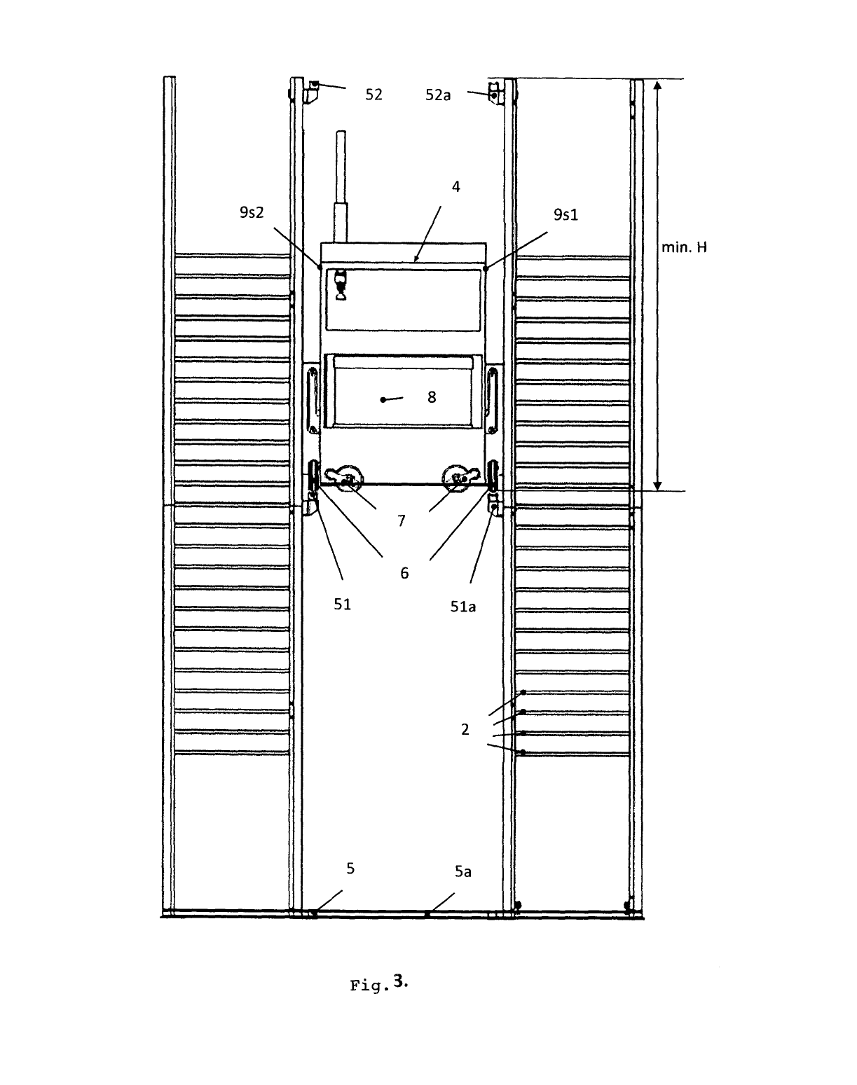

FIG. 3 the retrieval truck according to the invention with wheels engaging track is shown,

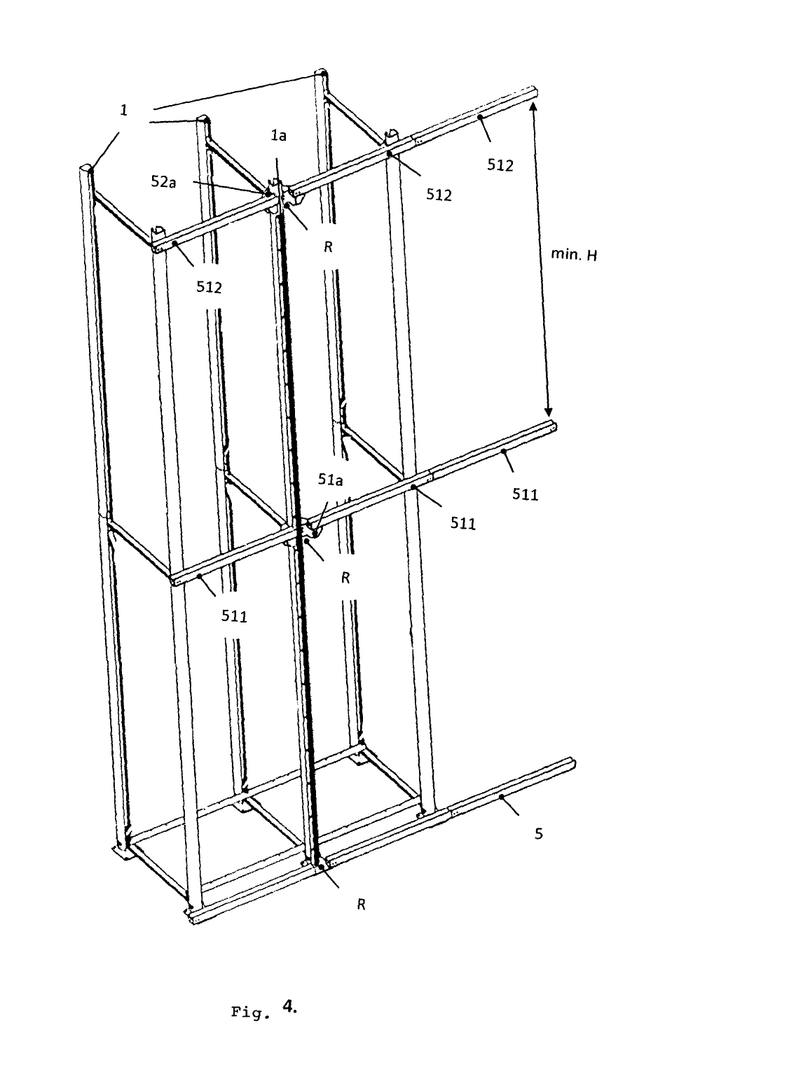

FIG. 4 shows arrangements of further tracks, in

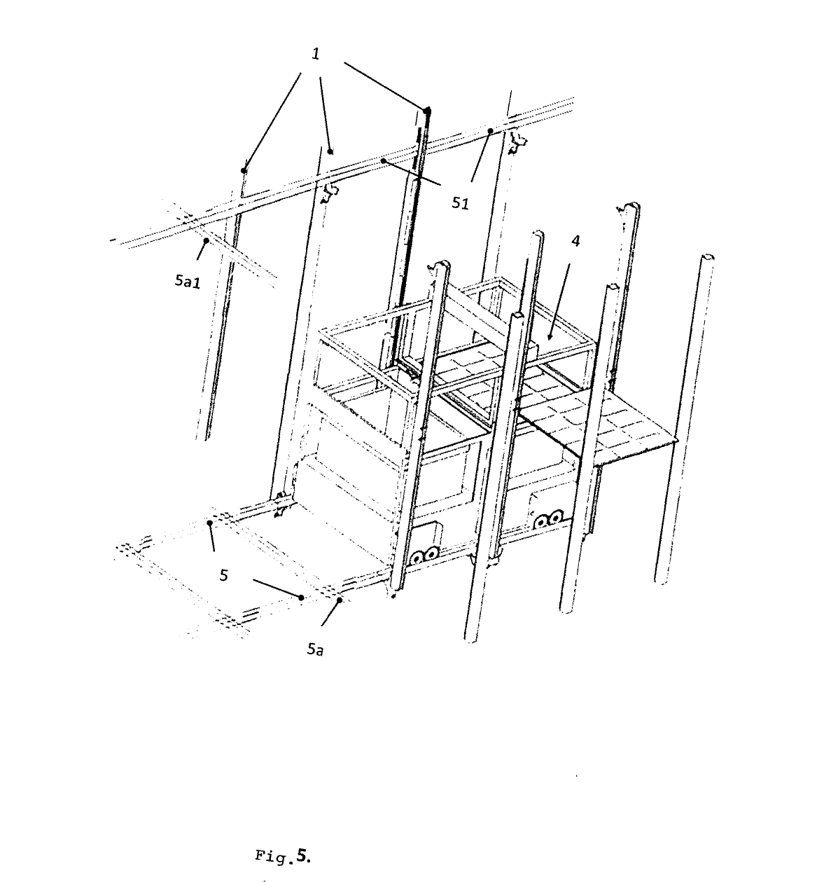

FIG. 5 arrangements of further tracks between cargo handling areas are shown, in

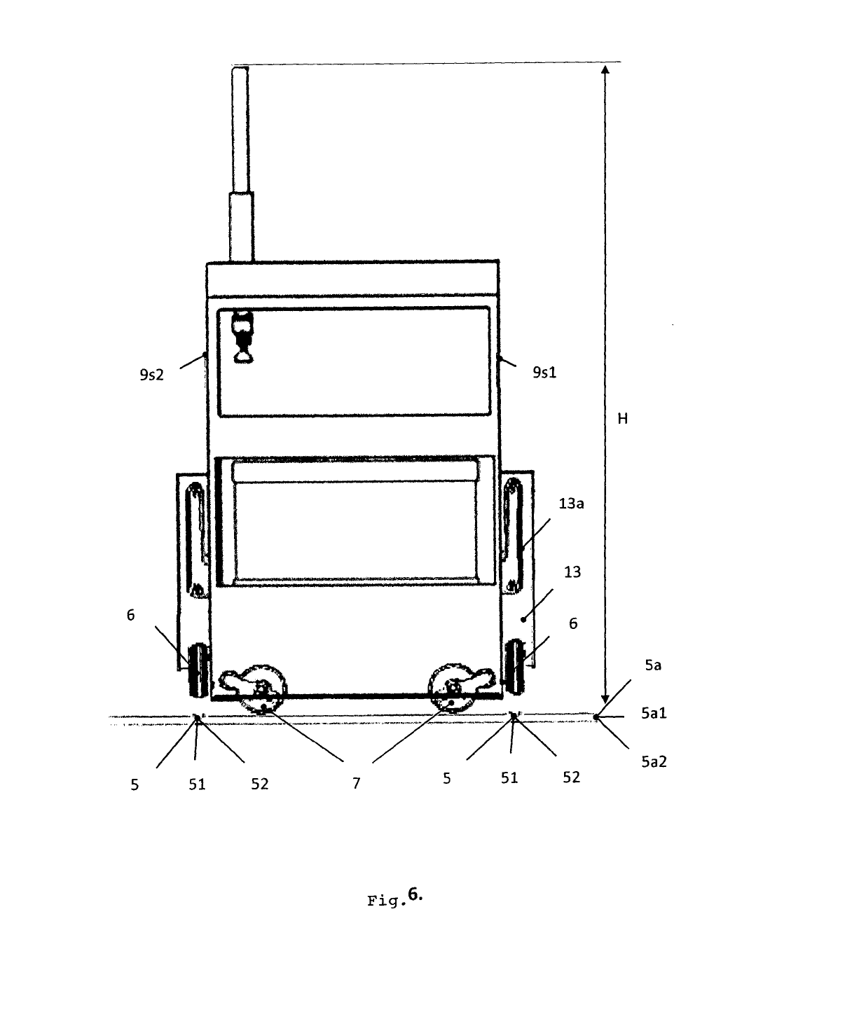

FIG. 6 position of retrieval truck on further tracks between cargo handling areas are shown,

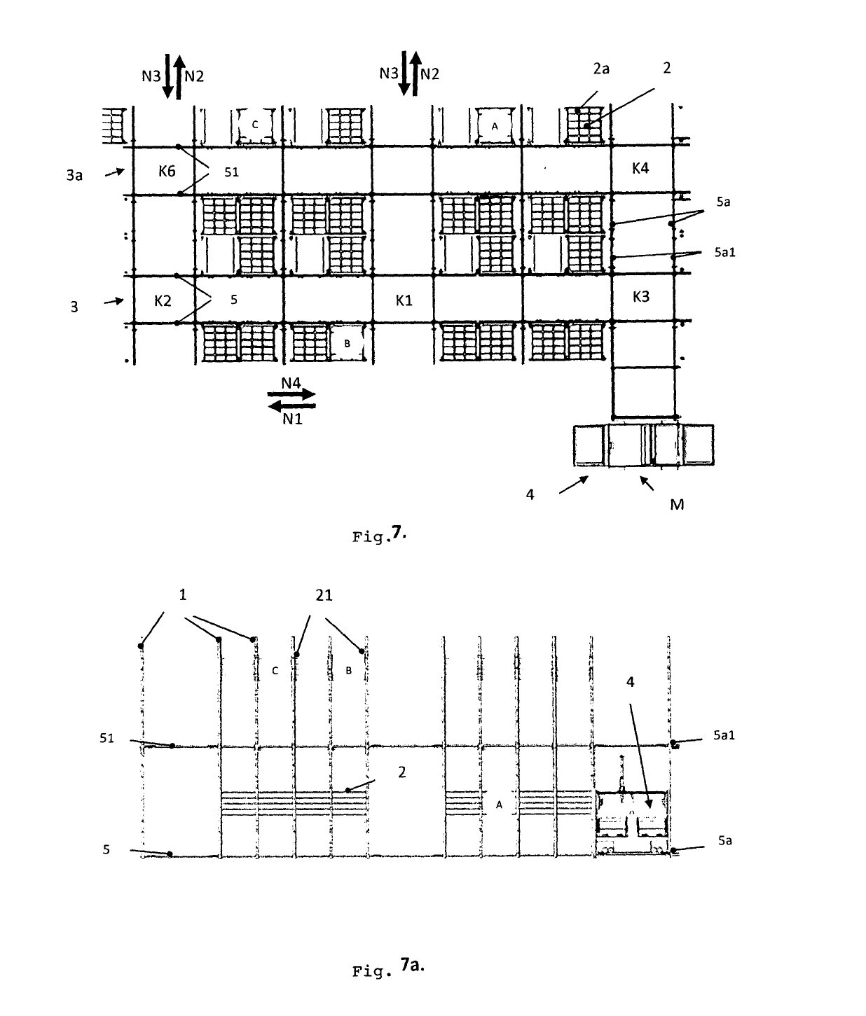

FIG. 7 depicts top view of a warehouse provided with a cargo handling system representing operation of the system according to the invention, and

FIG. 7a is a front elevational view of FIG. 7.

FIG. 1 shows a partial view of a preferred embodiment of the automatic cargo handling system for warehouses according to the invention. In this embodiment the automatic cargo handling system contains storage units 2 (e.g. crates, containers, pallets or shelves) arranged on columns 1 and a handling equipment formed as a high-lift order picker or retrieval truck 4 movable in a cargo handling area 3 formed between rows of columns 1. In this embodiment a track 5 formed by two parallel rails is arranged parallelly to the lines of columns 1 on the floor of handling area 3. The storage units 2 are preferably displaceable on guiding elements 21 (e.g. L-profiles, roller tables) toward the handling area 3, although the system according to the present invention is feasible by using stable storage units 2 fixed to the columns 1. On surface 2a of each storage unit 2 stored goods or articles are placed, or can be placed. A passive lifting element 1a of a lifting device preferably a toothed rack as seen in FIG. 1 is arranged on columns 1, to which an active lifting element 13 of said lifting device arranged on a retrieval truck 4 can be engaged, when a lifting action of the retrieval truck 4 is required to be processed. If the passive lifting element 1a consists of a toothed rack, the active lifting element 13 is provided by a chain belt 13a as seen in FIG. 2, or if the passive lifting element 1a consists of e.g. a rope (not seen in figures) the active lifting element 13 is provided by a rope drum. The retrieval truck 4 can move along the track 5 on wheels 6 fitted with track 5 in the handling area 3.

As it is shown in the figure, a track 5a crossing track 5 is provided outside the loading space 3, extending perpendicularly to the track 5 along the lines of columns, in which the retrieval truck 4 can approach e.g. a further handling area 3a having a track 5 similar to the track 5 on its ground level.

A preferred structure of the retrieval truck 4 is illustrated in FIG. 2. In this embodiment the retrieval truck 4 can move along the track 5 by wheels 6 and along the track 5a by wheels 7. Wheels 6, 7 are provided by a drive for moving retrieval truck 4 along the track 5,5a, and for moving the wheels 6, 7 between two positions in an axial direction M2 perpendicular to the side walls 9s1, 9s2 of the retrieval truck 4. The wheels 7 are vertically movable by the drive between two positions relative to the frame 9 of the retrieval truck 4, that is a lower and an upper position, and can be fixed in both positions. In this embodiment the retrieval truck 4 has at least two wheels 7 on each sides perpendicular to side walls 9s1, 9s2, only two of which are visible in this figure. When the wheels 7 of the retrieval truck 4 are situated just above the track 5a, while the retrieval truck is supported by the track 5 through its wheels 6, positioning the wheels 7 in a lower position the wheels 7 come in contact with the track 5a and wheels 6 are lifted off the track 5 together with the retrieval truck 4. Then the retrieval truck 4 can ride along track 5a on wheels 7 in a direction perpendicular to the handling areas 3,3a. When the wheels 7 are in the upper position, the retrieval truck 4 can ride along track 5 on wheels 6 in the handling area 3,3a. For the simplest embodiment of the system according to the invention, in which only a single handling area 3 is provided the track 5a and wheels 7 can be omitted.

In a preferred embodiment shown in FIG. 2 the retrieval truck 4 is provided with two gathering bins 8 preferably removably fitted to the frame 9 of retrieval truck 4. In this embodiment storage units 2 are located on leading elements 21, therefore, a tractive element 10 suitable for guiding and holding the storage units 2, e.g. an endless drag chain as shown in the figure, is arranged above gathering bins 8, by means of which the storage unit 2 can be drawn over gathering bins 8 along the leading elements 21 (e.g. L-profiles, guide rolls) in direction M1, that is into the frame 9 of the retrieval truck 4. The retrieval truck 4 can be formed by more than one gathering bins.

A manipulator 11 movable in a direction A on e.g. a guiding rail 12 arranged on the frame of the retrieval truck 4 can grasp an object disposed in/on a storage unit 2 and lift it even so the storage unit 2 cannot be moved in the direction M1, since the manipulator 11 can be displaced on the guiding rail 12 arranged on the frame and can access the fixed storage unit 2. Manipulator 11 may be also equipped with a device that allows unique identification of individual articles. Grasping the products may be occurred either by vacuum or mechanical forceps arms, or e.g. an electromagnet as well. If the storage unit 2 is pushed back to the leading element 21 (e.g. L-profile, roller line) by the tractive element 10, the given article can be placed by the manipulator 11 into the gathering bin 8.

Since the storage units 2 arranged on guide members 21 or fixed directly to the columns 1 can be displaced at various levels between the columns 1, it may be necessary to lift the retrieval truck 4 within the handling area. To this end, the active lifting element 13 e.g. a cogwheel or roller chain 13a of the retrieval truck 4 engaging a passive lifting member 1a applies a lifting force to the retrieval truck 4, so that the retrieval truck 4 can be hoisted to the height of a given storage unit 2 displaced on a guide member 21, so that the guide member 21, e.g. L-profile or roller conveyor and the tractive elements 10 get in the same plane. The active lifting element 13 can be moved out of the lateral surfaces 9s1, 9s2 of the retrieval truck 4 so that the active lifting element 13, for example a roller chain 13a can be engaged the passive lifting element 1a e.g. a tooth rack, while it can be withdrawn inside the lateral surfaces 9s1, 9s2 before beginning of any horizontal movement of the retrieval truck 4.

In FIG. 3 a preferred embodiment of the retrieval truck 4 according to the invention is shown, the wheels 6 of which are resting on the track 5. In the figure can be seen well that the wheels 6 in this position protrude from the lateral surface 9s1 of the frame 9 of retrieval truck 4, unlike the situation shown in FIG. 2, where the wheels 6 are located within the plane of side surface 9s1. The wheels 6 can be locked in their protruding position shown in FIG. 3. Tracks 51 similar to tracks 5 are fixed to columns 1 by brackets 51a. Further tracks 52 can also be mounted on columns 1 at a higher level by brackets 52a. Tracks 51, 52 unlike track 5 are not continuous, since the passive lifting element 1a crosses these tracks 51, 52. Therefore, tracks 51, 52 are interrupted forming a gap R near the passive lifting element 1a as shown in FIG. 4, and then continue.

In a specific embodiment, the width of a gap R between two consecutive track sections 511, 512 of the track 51, 52 are smaller than the diameter of the wheel 6, but larger than the width of the active lifting member 13, so that the wheel 6 can ride over the gap R. However, in a preferred embodiment at least two pairs of wheels 6 are arranged next to each other for each side wall 9s1, 9s2, in a manner shown in FIG. 2, the distance of axes of wheels 6 within the pairs is at least equal to or greater than the width of the gap R, so that the retrieval truck 4 can advance on the track 51,52 without any hitch. Use of such higher tracks 51, 52 eliminates the need for the retrieval truck 4 operating on a height of tracks 51,52 to descend to the track 5 in order to access further storage units 2 of farther columns 1 directly inaccessible from a ground track 5. Tracks 51,52 can be arranged in any number and arbitrary heights.

Similarly, tracks 5a1, 5a2—like tracks 51, 52 above track 5—may be arranged above track 5a as it is shown in FIG. 5 between two rows of columns 1 situated perpendicularly to handling areas 3,3a. Tracks 5a1, 5a2 are continuous in the figure, since hoisting the retrieval truck 4 takes place only by passive lifting elements 1a mounted perpendicularly to tracks 51, 52. A minimum difference between heights of tracks 5a, 5a1, 5a2 is at least equal to the total height H of a retrieval truck 4 in lower position (FIG. 6) supported by its wheels 7 fits into two adjacent tracks 5a, 5a1, 5a2 along the height of a column 1. Tracks 5a, 5a1, 5a2 are crossed preferably by tracks 5, 51, 52 enabling retrieval truck 4 to access any handling area 3,3a from each track 5a, 51a, 52a.

In FIG. 6, the retrieval truck 4 of a height H is positioned on track 5, 5a1, 5a2 with wheels 7 in the lower position on track 5a, 5a1, 5a2, while wheels 6 being in external position protrudes from side walls 9s1, 9s2.

Using the solution described above the retrieval truck 4 does not carry any storage unit 2 from handling area 3, 3a to a workstation M (FIG. 7) where the stored article can be e.g. manually removed from the storage unit 2, but only a receptacle 8 containing collected articles is to be conveyed to the storage units 2 and back to the workstation M.

Thus, the retrieval truck 4 according to the present invention is provided for moving articles stored or to be stored in a storage system of a warehouse according to the invention and—like devices of the prior art—contains a machine frame 9, active lifting member 13 mounted thereon, wheels 6 to be engaged tracks, drive means for driving the wheel as well as means for handling goods or articles. However, in a preferred embodiment the retrieval truck 4 according to the present invention further comprises: a gathering bin 8 arranged in the frame 9, a wheel 6 movable between two positions along at least an axial direction M2 perpendicular to the lateral surfaces 9s1, 9s2 of the retrieval truck 4 to be engaged with the track 5,51,52 in one of its two positions, and an active hoisting member 13 movable between two positions along said axial direction M2 perpendicular to the lateral surfaces 9s1, 9s2 of the retrieval truck 4 to be engaged in one of its two positions with a passive hoisting member 1a of the cargo handling system, and said means for moving goods comprises a manipulator 11 adapted for moving articles from a storing unit 2 into said gathering bin 8. This design enables the retrieval truck 4 on the one hand to carry only desired commodities in or out the warehouse instead of transporting storage units 2 containing a bulk of similar goods, and on the other hand there is no need for the retrieval truck 4 to descend to the ground of the warehouse in order to reach farther storage units, which is inaccessible from the ground at the same time. Since the retrieval truck 4 can preferably be provided with tractive elements 10 suitable for guiding, holding and moving the storage units 2 in a direction M1 perpendicular to the row of columns 1, the retrieval truck 4 has access to storage units arranged one above the other in a short distance, which perhaps impossible to reach even by hand, thus increasing the storage capacity of the warehouse.

Since the retrieval truck 4 can be provided also by wheels 7 movable between lower and upper positions to engage a track 5a,5a1,5a2 formed in an alley connecting and perpendicular to the tracks 5,51,52 of handling areas 3,3a, the retrieval truck 4 can move freely between the handling areas 3, 3a or even in different levels. The wheel 7 can be provided as a fixed one in a given embodiment, when the wheel 6 in its outer position can be adjusted to a lower position at crossings K1, K2, K3, K4, K5, K6 (FIGS. 7 and 7a.), in which position it lifts the retrieval truck 4 and its wheel 7 from the track 5a, 5a1, 5a2.

In the embodiment shown in Figures the retrieval truck 4 is provided by two gathering bins 8 and a tractive element 10 above each receptacle but may contain several receptacles 8 as well. In this case, the manipulator 11 is preferably arranged movably above the tractive elements 10 on a guiding rail 12 fixed to the machine frame 9 in order to reach the corresponding 8 bins. Of course, the retrieval truck 4 can be provided with more than one manipulator 11. As the gathering bin 8 is preferably detachably connected to the machine frame 9, it can be easily replaced at a workstation M (see FIG. 7, 7a.).

For the cargo handling system according to the present invention the retrieval truck 4 goes about the warehouse on the tracks 5,5a,51,51a,52,5a2 along a predetermined and optimally planned path, in a similar manner to the handling way of a manual warehouse, collecting stored articles to be delivered from storage units 2 in a gathering bin 8 by means of a manipulator 11, but displacing the storage units 2 almost not—that is moving a storage unit 2 from the leading element 21 to the tractive element 10 and back only at most.

Operation of a cargo handling system according to the invention will now be described through an exemplary embodiment of the system provided for a warehouse depicted by its top and side elevational views in FIGS. 7 (top) and 7a (side), respectively.

In these Figures the retrieval truck 4 is situated next to the delivery/collecting/packaging workstation M. In this example articles A, B, C are to be collected by means of the retrieval truck 4 from three different storage units 2 of the warehouse, then carrying them to the workstation M.

For the retrieval truck 4 article A is stored in a height between the tracks 5 and 51, but article B and C above the track 51.

Retrieval truck 4 leaves the workstation M and rolling on the track 5a on its wheels 7 in a direction of arrow N2. At crossing K4 the truck stops and, after its wheels 7 lifted into upper position, starts to move on its wheels 6 along the track 5, then goes ahead in a direction marked by arrow N1 inside the handling area 3a containing the article A as long as getting its active lifting member 13 aligned with a passive lifting member 1a arranged on a given column 1. In this position its active lifting members 13 (e.g. roller chains 13a) emerge from side walls 9s1,9s2 and engage the passive lifting member 1a (e.g. a toothed rack) and lift the truck 4. After the lifting process was started wheels 6 are getting drawn in behind the plane of walls 9s1,9s2. Lifting process continues so long as the tractive element 10 comes aligned with guiding element 21 supporting a storage unit 2. In that aligned position a tractive element 10 draws the storage unit 2 inside the frame 9 and manipulator 11 grasps the article A stored in the storage unit 2, then the latter is getting pushed back by the tractive element 10 into the guiding element 21. If the storage unit is fixed to the column 1 the manipulator 11 stretches in between the columns 1 to reach the article A and takes it in the bin 8.

Then the truck 4 is lifted further up by the active lifting members 13. As the lowest point of wheel 6 goes beyond above the level of the track 51 situated above the track 5, truck 4 is stopped and moves the wheels 6 into protruding position out of the plane of walls 9s1,9s2. When wheels 6 have already been fixed in that position active lifting elements 13 let the truck 4 descend to the track 51. Drawing back the active lifting element 13 truck 4 starts to run on track 51 in a direction signed by arrow N1 in the handling area 3a containing article C so long as its active lifting element 13 gets aligned with an adequate passive lifting element 1a fixed to a column 1. In this position active lifting elements 13a emerge from the plane of side walls 9s1,9s2 of the track 4 and engage the respective passive lifting elements 1a. At the beginning of lifting the truck 4 draws back the wheels 6 behind the plane of the walls 9s1,9s2 and continues to lift further so long as the tractive element 10 comes aligned with guiding element 21 supporting a storage unit 2 containing article C. In that aligned position a tractive element 10 draws the storage unit 2 inside the frame 9 and manipulator 11 grasps the article C stored in the storage area 2a, then the latter is getting pushed back by the tractive element 10 into the guiding element 21. If the storage unit is fixed to the column 1 the manipulator 11 stretches in between the columns 1 to reach the article C placed on an area 2a and takes it in the bin 8.

Then active lifting elements 13 let the truck 4 descend onto the track 51. Before the level of track 51 is reached wheels 6 move into their protruding position and get fixed, and descending further engage the track 51 similarly as described above. Truck 4 runs on track 51 in a direction signed by arrow N1 up to crossing K6. Then it takes its wheels 7 to a lower end position. The truck 4 runs on the track 51a in a direction of arrow N3 up to crossing K2. In crossing K2 takes its wheels 7 into upper end position and then runs along arrow N4 in the handling area 3 up to the position of the storage unit 2 containing article B so long as its active lifting element 13 gets aligned with an adequate passive lifting element 1a fixed to a column 1. In this position active lifting elements 13a (e.g. roller chains 13a) emerge from the plane of side walls 9s1,9s2 of the track 4 and engage the respective passive lifting elements 1a (e.g. toothed racks), and at the beginning of lifting the truck 4 draws back the wheels 6 behind the plane of the walls 9s1,9s2 and continues to lift further so long as the tractive element 10 comes aligned with guiding element 21 supporting a storage unit 2 containing article B.

In that aligned position a tractive element 10 draws the storage unit 2 inside the frame 9 and manipulator 11 grasps the article B stored in the storage area 2a, then the latter is getting pushed back by the tractive element 10 into the guiding element 21. If the storage unit is fixed to the column 1 the manipulator 11 stretches in between the columns 1 to reach the article B placed on an area 2a and takes it in the bin 8.

Then active lifting elements 13 let the truck 4 descend. Before the level of track 5 is reached wheels 6 move into their protruding position and get fixed. Truck 4 descending further to engage the track 5 and runs along arrow N4 up to crossing K3. At crossing K3 the wheels 7 of the truck 4 move into their lower position. The truck 4 returns in the workstation running on track 5a by its wheels 7 in a direction of arrow N3 and the articles collected are removed from the bin 8 at the workstation M.

Of course, the process as described above is suitable not only for collecting stored articles A, B, C, but also carrying articles A, B, C to be stored in the storage units 2 of the warehouse.

At the workstation M articles A, B, C can be removed from/taken into the bin 8 of the truck 4, but preferably the bin 8 itself can be removed from the truck 4 and replaced to another bin 8 being empty/containing articles to be stored. Then the truck 4 is ready for taking a new journey in the warehouse, which can be different from above path depending on the place of storing of articles to be stored/retrieved. Therefore, the system according to the invention is preferably provided by a programmable control unit controlling automatically or remotely the operation of truck 4 according to route-plans previously uploaded.

Power supply of the truck 4 can be provided e.g. by accumulators arranged onboard. The cargo handling system for warehouses according to the invention can operate more than one truck 4 at the same time, which can bypass each other on different tracks 5, 51, 52, 5a, 5a1, 5a2.

The most important advantage of the cargo handling system for warehouses according to the invention is that it eliminates the drawbacks of the prior art solutions, but without the use of manual labor, that is no need either transporting storing units 2 (like crates, pallets) containing articles A, B, C stored in the warehouse to a delivery workstation M or lowering the retrieval truck to the ground after each visit done at a storing unit 2 in the warehouse in order to store or deliver stored articles A, B, C by mechanical power. This solution saves substantial amount of energy, time and live labour as well, since the truck 4 is capable of either placing or removing even a single item in a storage unit 2 (e.g. a crate, a pallet) arranged in a shelf system, and forwarding the collected items to a delivery workstation or transporting items or goods to be stored to a predetermined storage unit placed in the storage shelving system, while other trucks 4 accomplish similar operations in the same warehouse.

1. Cargo handling system for warehouses, comprising at least one retrieval truck (4) movable in a cargo handling area (3) formed between at least two parallelly arranged rows of columns (1) and storing units (2) arranged on the columns (1), and a track (5) consisting preferably of two parallel rails arranged parallelly to the rows of columns (1) is installed in the handling area (3), and a passive hoisting member (1a) of a hoisting device connectable to an active hoisting member (13) of the hoisting device mounted on the retrieval truck (4) is arranged on the columns (1), and the system is provided with a control unit controlling the movement of the retrieval truck (4), characterized in that at least one further track (51,52) fixed to the columns (1) parallelly to the track (5) is arranged in the handling area (3), and the retrieval truck (4) comprises: a gathering bin (8), a manipulator (11) adapted for moving articles from a storing unit (2) into said gathering bin (8), wheels (6) to be fitted in the tracks (5,51,52) and movable between at least two positions taken in an axial direction (M2) perpendicular to the lateral surfaces (9s1, 9s2) of the retrieval truck (4), a drive for rotating and moving the wheels (6) in axial direction (M2), a further drive for operating and moving the active hoisting member (13) of the hoisting device between two positions taken in said axial direction (M2) perpendicular to the lateral surfaces (9s1, 9s2) of the retrieval truck (4), wherein the track (51,52) is discontinuated by a gap (R) in the vicinity of said passive hoisting member (1a).

2. The cargo handling system for warehouses according to claim 1, characterized in that the system comprises more than two rows of columns (1) arranged parallelly and handling areas (3,3a) therebetween; tracks (5a) formed by two parallel rails arranged perpendicularly to the rows of columns (1) for guiding the retrieval truck (4); and the retrieval truck (4) is provided by wheels (7) to be fitted to the track (5a) and movable between two different positions along a height (H) of the retrieval truck (4), and a driving unit for driving and moving said wheels (7) between the two positions; the track (5a) perpendicularly arranged to the rows of columns (1) and a track (5,51,52) arranged parallelly to the rows of columns (1) constitute a crossing (K3,K4).

3. The cargo handling system for warehouses according to claim 2, characterized in that the system comprises at least one further track (5a1,5a2) arranged perpendicularly to the rows of columns (1), and a vertical distance between the tracks (5a,5a1,5a2) parallelly arranged to the rows of columns (1) is at least equal to the height (H), and the further track (5a1,5a2) arranged perpendicularly to the rows of columns (1) and the track (5,51,52) arranged parallelly to the rows of columns (1) constitute a crossing (K1,K2,K3,K4,K6).

4. The cargo handling system for warehouses according to claim 3, characterized in that a vertical distance between tracks (5,51,52) arranged parallelly to the rows of columns (1) is at least equal to the height (H).

5. The cargo handling system for warehouses according to claim 4, characterized in that said manipulator (11) adapted for moving articles is arranged on a guiding rail (12) formed on a frame (9) of the retrieval truck (4).

6. The cargo handling system for warehouses according to claim 5, characterized in that the retrieval truck (4) is provided at least two pairs of wheels (6) on each of its lateral surface (9s1, 9s2), wherein the distance of axes of wheels (6) in each pair of wheels (6) is at least equal to or greater than a width of the gap (R).

7. The cargo handling system for warehouses according to claim 6, characterized in that the storing units (2) are arranged movably in a direction (M1) toward the handling area (3) on a guiding element (21) fixed to the column (1), and the retrieval truck (4) is provided with a tractive element (10) suitable for guiding, retaining as well as driving the storing units (2) in perpendicular direction (M1) to the rows of columns (1).

8. The cargo handling system for warehouses according to claim 7, characterized in that said gathering bin (8) is releasably clamped to the retrieval truck (4).

9. A retrieval truck (4) for moving goods stored or being to be stored in a cargo handling system according to claim 1, having a frame (9) equipped with active hoisting member (13), wheels (6) to be engaged with tracks (5,51,52), drive means for driving said wheels (6), and means for moving goods, characterized in that the retrieval truck (4) further comprises: a gathering bin (8) arranged in the frame (9), a wheel (6) movable between two positions along at least an axial direction (M2) perpendicular to the lateral surfaces (9s1, 9s2) of the retrieval truck (4) to be engaged with the track (5,51,52) in one of its two positions, and an active hoisting member (13) movable between two positions along said axial direction (M2) perpendicular to the lateral surfaces (9s1, 9s2) of the retrieval truck (4) to be engaged in one of its two positions with a passive hoisting member (1a) of the cargo handling system, and said means for moving goods comprises a manipulator (11) adapted for moving articles from a storing unit (2) into said gathering bin (8).

10. A retrieval truck (4) according to claim 9, characterized in that further comprises a tractive element (10) suitable for guiding, retaining as well as driving the storing units (2) in perpendicular direction (M1) to the rows of columns (1).

11. A retrieval truck (4) according to claim 10, characterized in that further comprises a wheel (7) movable between two different positions and to be engaged in its lower position with a track (5a,5b,5c) perpendicularly arranged to the track (5,51,52) of the cargo handling system.

12. A retrieval truck (4) according to claim 11, characterized in that further comprising a tractive element (10) arranged above the gathering bin (8), and said manipulator (11) is mounted on a guiding rail (12) attached to the frame (9) above the tractive element (10).

13. A retrieval truck (4) according to claim 12, characterized in that said gathering bin (8) is releasably clamped to the frame (9).
